(19) United States
(12) Patent Application Publication
(10) Pub. No.: US 2008/0120340 A1
(43) Pub. Date: May 22, 2008

(54) Image Forming System, Image Forming Apparatus, Job Administrating Method and Job Administrating Program

(75) Inventor: Yasuhiro Hashimoto, Osaka-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/874,234

(22) Filed: Oct. 18, 2007

(30) Foreign Application Priority Data
Nov. 22, 2006 (JP) 2006-316284

(51) Int. Cl. G06F 7/00

(52) U.S. Cl. 707/104.1; 707/E17.009

(57) ABSTRACT

An image forming system comprising a plurality of image forming apparatuses interconnected via a network, wherein an image forming apparatus is capable of transmitting image data to another image forming apparatus, and the image forming apparatus capable of transmitting the image data comprising: a transmitter that transmits image data to another image forming apparatus; a job log information storage; and a job administrator that gives a job ID to job log information indicating a job executed on the image data then stores the job log information in said job information storage, and gives a job ID that is the same as or related to the job ID given to the job log information, to the image data to be transmitted by said transmitter, and the image forming apparatus receiving the image data comprising: a receiver that receives image data with a job ID, which is transmitted from another image forming apparatus; a job log information storage; and a job administrator that gives a job ID that is the same as or related to said job ID given to the image data received by said receiver, to job log information indicating a job executed on the image data, then stores the job log information in said job log information storage.

This application claims priority under 35 U.S.C. § 119 to Japanese Patent Application No. 2006-316284 filed on Nov. 22, 2006, the entire disclosure of which is incorporated herein by reference in its entirety.

### BACKGROUND OF THE INVENTION

1. Field of the Invention

The present invention relates to an image forming system for example having a plurality of image forming apparatuses such as MFPs (Multi Function Peripherals) that are digital multifunctional machines, which are interconnected via a network, an image forming apparatus used in the image forming system, a job administrating method, and a job administrating program stored in a computer readable recording medium so as to make a computer in the image forming apparatus execute a job administrating process.

2. Description of the Related Art

The following description sets forth the inventor's knowledge of related art and problems therein and should not be construed as an admission of knowledge in the prior art.

In response to the growing security concerns of recent years, job log information is stored in an image forming apparatus such as a MFP, so that a user could track a job executed in the image forming apparatus.

Conventional image forming apparatuses mentioned right above, exchange image data with each other. However, even if jobs are sequentially executed in the respective image forming apparatuses and actually related to each other, job log information of the jobs are stored individually with no relationships between the jobs in the respective image forming apparatuses. Thus, it is an issue that relationships between the jobs are hardly figured out and the jobs are not easily tracked.

According to Japanese Laid-open Patent Publication No. 2001-005629, print logs are accumulated via a network in one location, so as to be administered and tracked.

With this art disclosed in the publication right above, usage status of a printer is figured out. However, this art is not to track easily jobs sequentially executed in a plurality of image forming apparatuses interconnected via a network, and job log information of jobs sequentially executed in a plurality of image forming apparatuses are stored individually with no relationships of the jobs in the respective plurality of apparatuses, which is the same as the conventional art. Thus, this art still does not resolve the previously mentioned issue that relationships between the jobs are hardly figured out and the jobs are not easily tracked.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image forming system easily tracking jobs sequentially executed in a plurality of image forming apparatuses and related to each other.

It is another object of the present invention to provide an image forming apparatus preferably used in the system.

It is yet another object of the present invention to provide a job administrating method preferably used for the system.

It is still yet another object of the present invention to provide a job administrating program stored in a computer readable recording medium, to make a computer in the image forming apparatus execute a job administrating process.

According to a first aspect of the present invention, an image forming system comprises a plurality of image forming apparatuses interconnected via a network, wherein an image forming apparatus is capable of transmitting image data to another image forming apparatus, and the image forming apparatus capable of transmitting the image data comprises:
a transmitter that transmits image data to another image forming apparatus;
a job log information storage; and
a job administrator that gives a job ID to job log information indicating a job executed on the image data then stores the job log information in said job information storage, and gives a job ID that is the same as or related to the job ID given to the job log information, to the image data to be transmitted by said transmitter, and
   the image forming apparatus receiving the image data comprising:
a receiver that receives image data with a given job ID, which is transmitted from another image forming apparatus;
a job log information storage; and
a job administrator that gives a job ID that is the same as or related to said job ID given to the image data received by said receiver, to job log information indicating a job executed on the image data, then stores the job log information in said job log information storage.

According to a second aspect of the present invention, an image forming apparatus is capable of being interconnected to another image forming apparatus via a network, and comprises:
a transmitter that transmits image data to another image forming apparatus;
a receiver that receives image data transmitted from another image forming apparatus;
a job log information storage;
a job administrator that gives a job ID to job log information indicating a job executed on the image data then stores the job log information in said job log information storage, and gives a job ID that is the same as or related to the job ID given to the job log information, to the image data to be transmitted by said transmitter, and then, if the image data received by said receiver has a given job ID, gives a job ID that is the same as or related to said job ID given to the image data, to job log information indicating a job executed on the image data, then stores the job log information in said job log information storage.

According to a third aspect of the present invention, a job administrating method used in an image forming system comprising a plurality of image forming apparatuses interconnected via a network, wherein the same job IDs or related job IDs to be shared among respective image forming apparatuses, are given to job log information of jobs sequentially executed in the respective image forming apparatuses on image data exchanged between the image forming apparatuses, and the job log information are administered by the job IDs.

According to a fourth aspect of the present invention, a job administrating method comprising:
a step executed in an image forming apparatus transmitting image data, to give a job ID to job log information indicating a job executed on the image data then store the job log information in a job log information storage, and give a job ID that is the same as or related to the job ID given to the job log information, to the image data to be transmitted to another image forming apparatus;
a step executed in an image forming apparatus receiving image data, to receive the image data with the given ID, which is transmitted from said sender image forming apparatus; and
a step executed in said receiver image forming apparatus, to give a job ID that is the same as or related to said job ID given to the received image data, to job log information indicating a job executed on the image data, then store the job log information in the job log information storage.

According to a fifth aspect of the present invention, a job administrating program stored in a computer readable recording medium, to make a computer in an image forming apparatus execute:
a step to transmit image data to another image forming apparatus via a network;
a step to receive image data transmitted from another image forming apparatus;
a step to give a job ID to job log information indicating a job executed on the image data then store the job log information in a job log information storage, and give a job ID that is the same as or related to the job ID given to the job log information, to the image data to be transmitted, and then, if the received image data has a given job ID, give a job ID that is the same as or related to the job ID given to the image data, to job log information indicating a job executed on the image data, then store the job log information in said job log information storage.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a diagram showing an overall configuration of an image forming system according to one embodiment of the present invention;

FIG. 2 is a block diagram showing a configuration of an image forming apparatus;

FIG. 3 is a flowchart showing operations performed by a sender image forming apparatus, to transmit image data read out from a document by a scanner of the sender image forming apparatus, to another image forming apparatus belonging to the same group as the sender image forming apparatus;

FIG. 4 is a flowchart showing operations performed by an image forming apparatus that is a receiver image forming apparatus;

FIG. 5 is a view showing an example of conventional job log information stored in a job log information storage in the sender image forming apparatus and the receiver image forming apparatus;

FIG. 6 is a view showing an example of job log information stored in a job log information storage in the sender image forming apparatus and the receiver image forming apparatus according to one embodiment of the present invention;

FIG. 7 is a view showing another example of job log information stored in a job log information storage in the sender image forming apparatus and the receiver image forming apparatus according to one embodiment of the present invention;

FIG. 8 is a view showing an example of job log information displayed on an operation panel, which is stored in the respective image forming apparatuses;

FIG. 9 is a view showing another example of job log information displayed on an operation panel, which is stored in the respective image forming apparatus;

FIG. 10 is an explanatory view showing another example of a method to administrate job log information;

FIG. 11 is an explanatory view showing yet another example of a method to administrate job log information; and

FIG. 12 is an explanatory view showing still yet another example of a method to administrate job log information.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

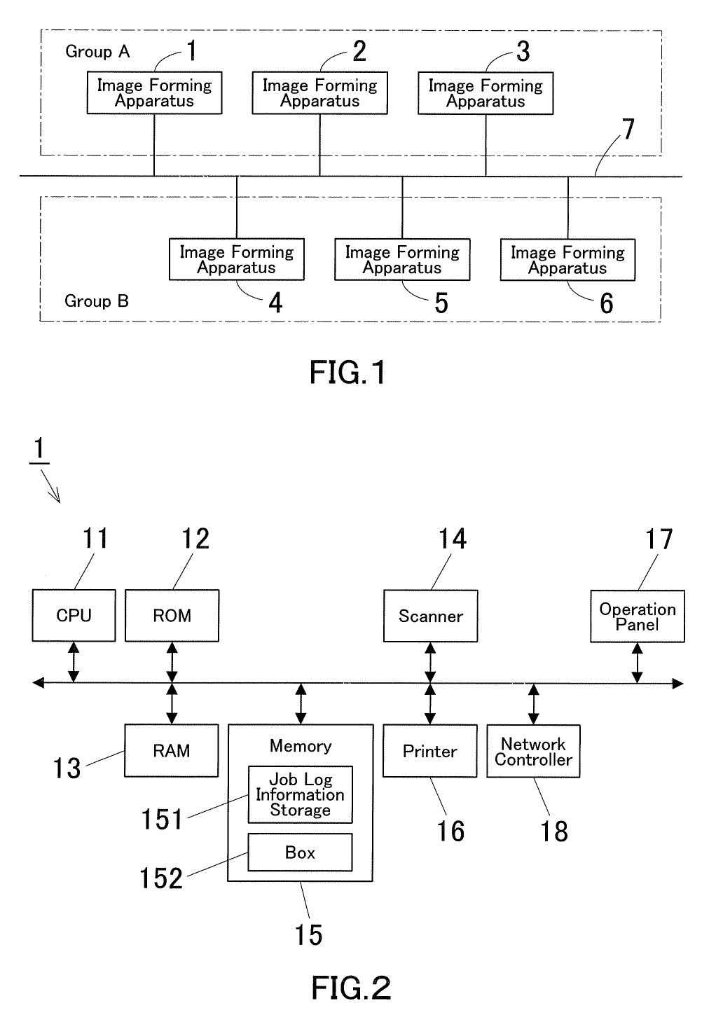

As shown in FIG. 1, an image forming system comprises image forming apparatuses 1 through 6 interconnected via a network, and image data is exchanged among the image forming apparatuses via the network.

The plurality of image forming apparatuses are divided into a plurality of groups, for example, the image forming apparatuses 1 through 3 belong to Group A, and the image forming apparatuses 4 through 6 belong to Group B.

In this embodiment, a MFP that is a multifunctional machine is employed as the image forming apparatuses 1 through 6.

Hereinafter, a configuration of the image forming apparatus 1 will be explained with reference to a block diagram shown in FIG. 2, on behalf of the image forming apparatuses 1 through 6, since their configurations are the same.

As shown in FIG. 2, the image forming apparatus 1 is a MFP as previously mentioned, and comprises a CPU 11, a ROM 12, a RAM 13, a scanner 14, a memory 15, a printer 16, an operation panel 17 and a network controller (NIC) 18.

The CPU 11 controls the overall image forming apparatus 1. Further, when a job is executed in the image forming apparatus 1, for example, to receive, copy, fax or scan image data, the CPU 11 generates job log information indicating the executed job then stores the job log information in the memory 15 so as to administrate. Detailed explanation about a job administrating method will be provided later.

The ROM 12 is a memory to store an operation program for the CPU 11.

The RAM 13 is a memory to provide an operation area where the CPU 11 executes a process according to the operation program.

The scanner 14 reads an image on a document placed on a document table (not shown in Figure) then outputs image data.

The memory 15 is a nonvolatile recording medium such as a hard disk drive (HDD), and comprises a job log information storage 151 and a plurality of boxes 152 that are directories storing data in segments therein. The job log information is stored in the job log information storage 151, meanwhile image data read out from a document by the scanner 14, image data transmitted from another image forming apparatus or a user terminal, and other data are stored in the boxes 152 according to user instruction.

The printer 16 prints image data read out from a document by the scanner 14, print data transmitted from a user terminal, and other data, by a specified mode.

The operation panel 17 is used for various entry operations, and comprises a display such as a liquid crystal display.

The network controller 18 controls communication with another image forming apparatus and an external apparatus other than the image forming apparatus, such as a user terminal, which are on the network.

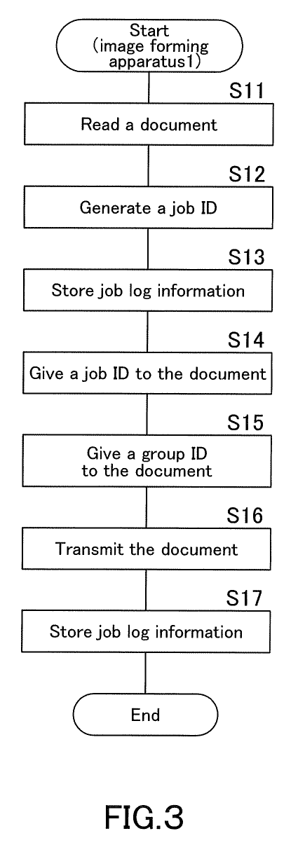

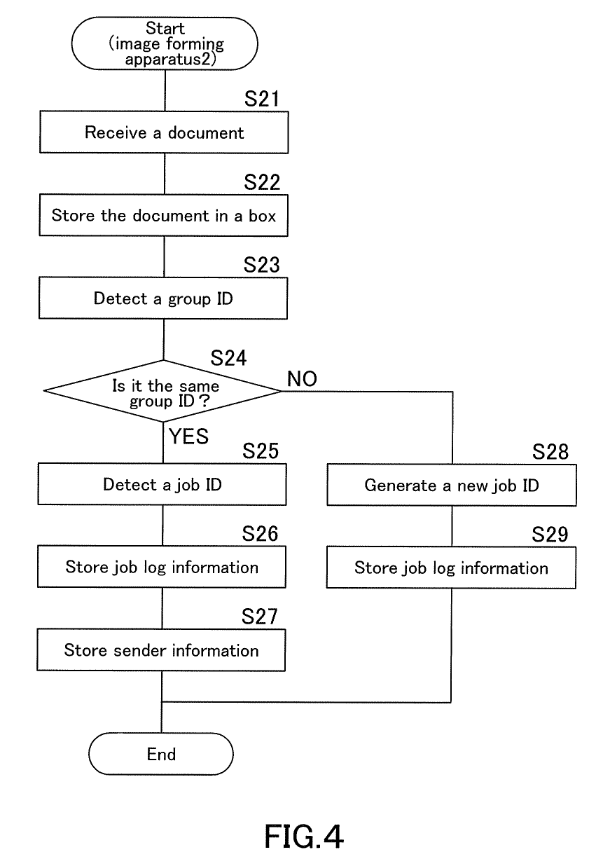

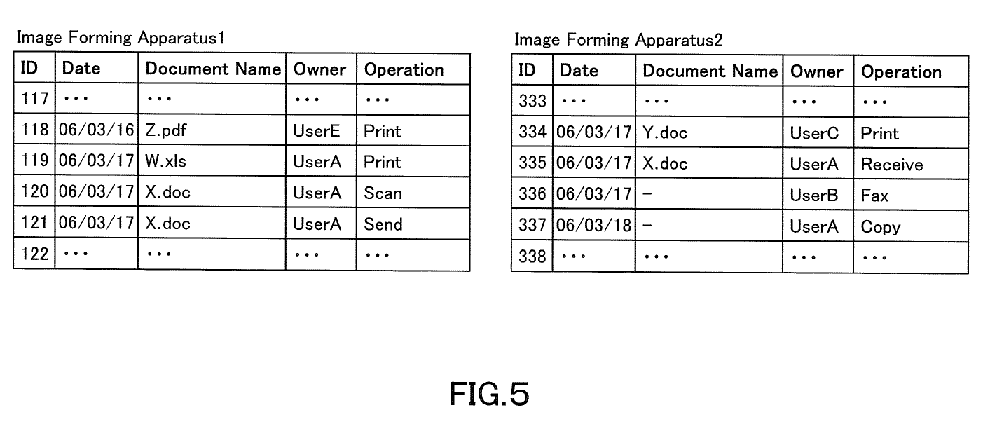

FIG. 3 is a flowchart showing operations performed by the image forming apparatus 1 that is a sender image forming apparatus, to transmit image data (hereinafter, will be also referred to as “document”) read out from a document by the scanner 4 of the image forming apparatus 1, to another image forming apparatus (for example, the image forming apparatus 2) belonging to Group A that is the same group as the image forming apparatus 1. On the other hand, FIG. 4 is a flowchart showing operations performed by the image forming apparatus 2 that is a receiver image forming apparatus.

The operations shown in the flowchart in FIG. 3 and FIG. 4 are executed by the CPU 11 in the image forming apparatus 1 and the image forming apparatus 2, according to a program stored in a recording medium such as the ROM 12.

As shown in FIG. 3, under the control of the CPU 11, a document is read by the scanner 14 in the image forming apparatus 1 in Step S11, and a job ID is generated in Step S12. In Step S13, the generated job ID is given to job log information indicating the job executed to read the document, then the job log information is stored in the job log information storage 151 in the memory 15.

In Step S14, a job ID that is the same as the job ID given to the job log information is given to the document (image data). Then in Step S15, a group ID is given to the document (image data) to indicate that the image forming apparatus 1 belongs to Group A.

Subsequently, in Step S16, the image data is transmitted to the image forming apparatus 2 via the network controller 8. Then in Step S17, a job ID is given to job log information indicating the job executed to transmit the image data, then the job log information is stored in the job log information storage 151. The given job ID is the same as or related to the job ID given to the job log information indicating the job executed to read the document, since these jobs are executed on the same document.

On the other hand, under the control of the CPU 11 of the image forming apparatus 2, a document is received by the network controller 18 in Step S21 of FIG. 4. Then, the image data is stored in the box 152 in Step S22, and the group ID given to the document is detected in Step S23. Then, it is judged in Step S24 whether or not the detected group ID is the same as the group ID of the image forming apparatus 2.

If the detected group ID is the same (YES in Step S24), the job ID given to the image data is detected in Step S25. Then in Step S26, a job ID that is the same as or related to the detected job ID is given to job log information indicating the job executed to receive the document, and the job log information is stored in the job log information storage 151.

Subsequently, in Step S27, sender information indicating the image forming apparatus 1 that is the sender of the document, is related to the job ID given to the job log information, then stored in the job log information storage 151. Then, the routine terminates.

Meanwhile, if the detected group ID is not the same (NO in Step S24), a new job ID is generated in Step S28. Then in Step S29, the new job ID is given to job log information indicating the job executed to receive the document, then the job log information is stored in the job log information storage 151. Then, the routine terminates.

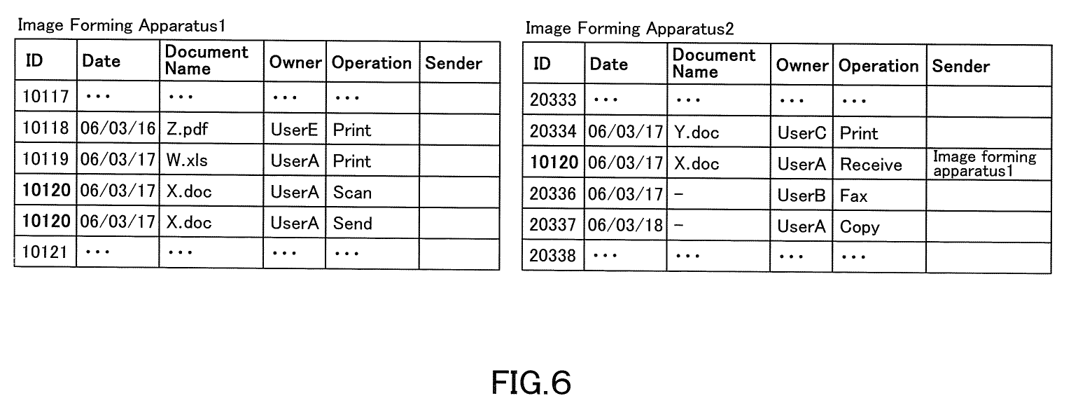

FIG. 5 is a view showing an example of conventional job log information stored in the job log information storage 151 in the image forming apparatus 1 and the image forming apparatus 2, and FIG. 6 is a view showing an example of job log information according to one embodiment of the present invention.

The Job log information includes a job ID, a job execution date, a document name, an owner and an operation. Among the job log information stored in the image forming apparatus 1, the job ID 120 indicates a job executed to read a document, and the job ID 121 indicates a job executed to transmit a document.

As shown in FIG. 5, among the job log information stored in the image forming apparatus 2, the job ID 335 indicates a job executed to receive a document transmitted from the image forming apparatus 1. The job IDs 120, 121 and 335 indicate jobs sequentially executed on one same document (and related to each other), but the job IDs are not related to each other. Thus, a user hardly recognizes relationships between the jobs.

On the contrary, as shown in FIG. 6, job IDs 10120 are given to jobs to indicate that the jobs are sequentially executed on one same document and related to each other, in other words, the jobs are executed in the image forming apparatus 1 to read and transmit a document then executed in the image forming apparatus 2 to receive the document. Further, sender information (Sender) is given to the job executed to receive the document.

In this way as described above, job IDs are given to job log information indicating jobs executed on a document exchanged between the image forming apparatuses 1 and 2, and the job log information is administrated by the job IDs shared with the image forming apparatuses. Thus, it is easy to track jobs sequentially executed in a plurality of image forming apparatuses and related to each other, which could enhance the security level of an image forming apparatus and an image forming system.

Further, sender information indicating the sender of a received document is related to a job ID given to the document, then stored in the job log information storage 151. Thus, based on the sender information, job log information indicating a job executed on the document, which is stored in the sender image forming apparatus, is easily acquired. Further, since job log information indicating jobs executed in other image forming apparatuses are not stored in the job log information storage 151, the job log information storage 151 has less possibility to run out of its capacity.

Meanwhile, the job ID is preferably unique to be tracked more easily. For example, the unique job ID is a code that is a combination of a MAC address and a job generation date/time.

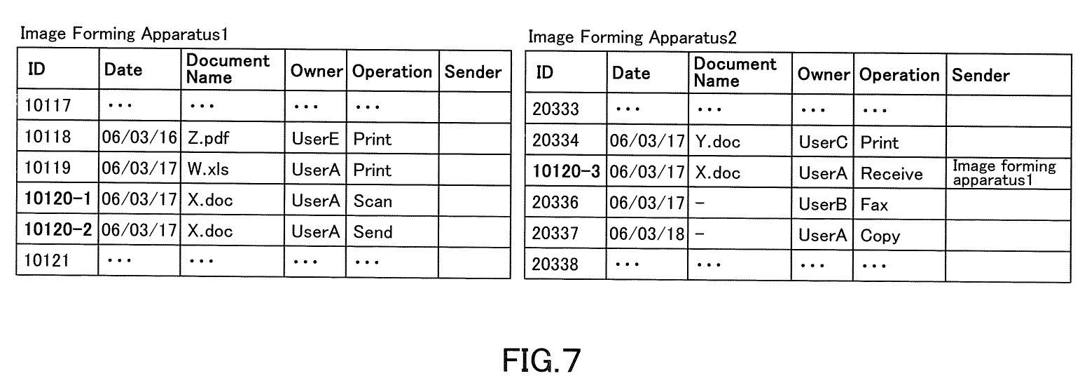

FIG. 7 is a view showing another example of job log information stored in the job log information storage 151 in the image forming apparatus 1 and the image forming apparatus 2.

In this embodiment, job IDs related to each other are given to respective jobs sequentially executed on a document, in other words, jobs executed in the image forming apparatus 1 to read and transmit a document and a job executed in the image forming apparatus 2 to receive the document. Concretely, the respective job IDs include branch numbers given after the same codes (10120). Thus, the number of jobs sequentially executed on the document is easily recognized from the branch numbers.

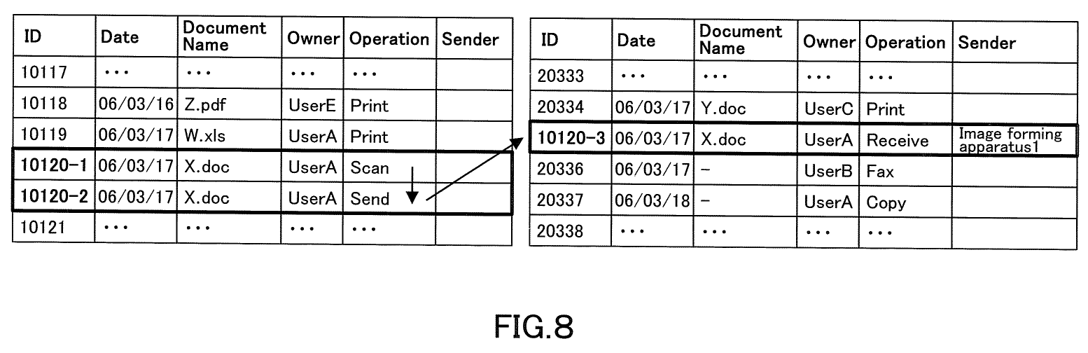

FIG. 8 is a view showing an example of job log information displayed on an operation panel of the image forming apparatus 1 or 2 using application software installed on the image forming apparatus 1 or 2, and the job log information is stored in the image forming apparatuses 1 and 2.

In this embodiment, job log information indicating jobs that are sequentially executed on a document and have job IDs including given branch numbers are enclosed by heavy line, and the order of being executed is indicated by arrows.

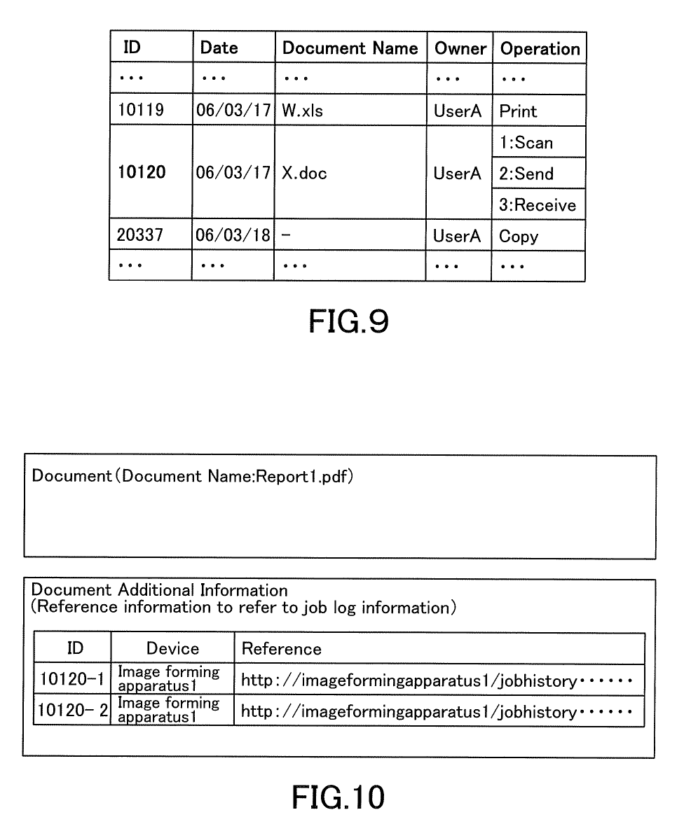

FIG. 9 is a view showing another example of job log information displayed on an operation panel of the image forming apparatus 1 or 2, which are stored in the image forming apparatuses 1 and 2.

In this embodiment, job log information stored in the image forming apparatuses 1 and 2 are consolidated, and it is recognized from the “operation” column, that jobs with the job IDs starting from 10120 are sequentially executed to read, transmit and receive a document.

FIG. 10 is a view showing another example of a method to administrate job log information. In this embodiment, job log information indicating jobs executed to read and transmit a document is stored in the job log information storage 151 in the sender image forming apparatus 1. And at the time of transmitting the document, reference information to refer to the job log information stored in the job log information storage 151 is given to the document. And then, the document is transmitted to the image forming apparatus 2 from the image forming apparatus 1.

In the image forming apparatus 2 receiving the document with the given reference information, the document is stored in a predetermined box 152 with the reference information. And job log information indicating the job executed to receive the document is stored in the job log information storage 151. The job ID stored with the job log information is a job ID that is the same as or related to the job ID given to the document in the image forming apparatus 1.

If the document is further transmitted to the image forming apparatus 3 belonging to the same group, reference information to refer to the job log information indicating the job executed to receive the document from the image forming apparatus 1 and the job executed to transmit the document to the image forming apparatus 3, are given to the document.

In this way as described above, when the document is transmitted to another image forming apparatus, reference information to refer to job log information indicating a job executed on a document in an image forming apparatus is given to the document. Thus, a target device storing the job log information is easily figured out by just taking a look of the reference information given to the document, without bothering to acquire or search the job log information in respective image forming apparatuses. Further, job log information indicating jobs sequentially executed and related to each other are easily tracked, since job IDs that are the same as or related to each other are given to the respective job log information.

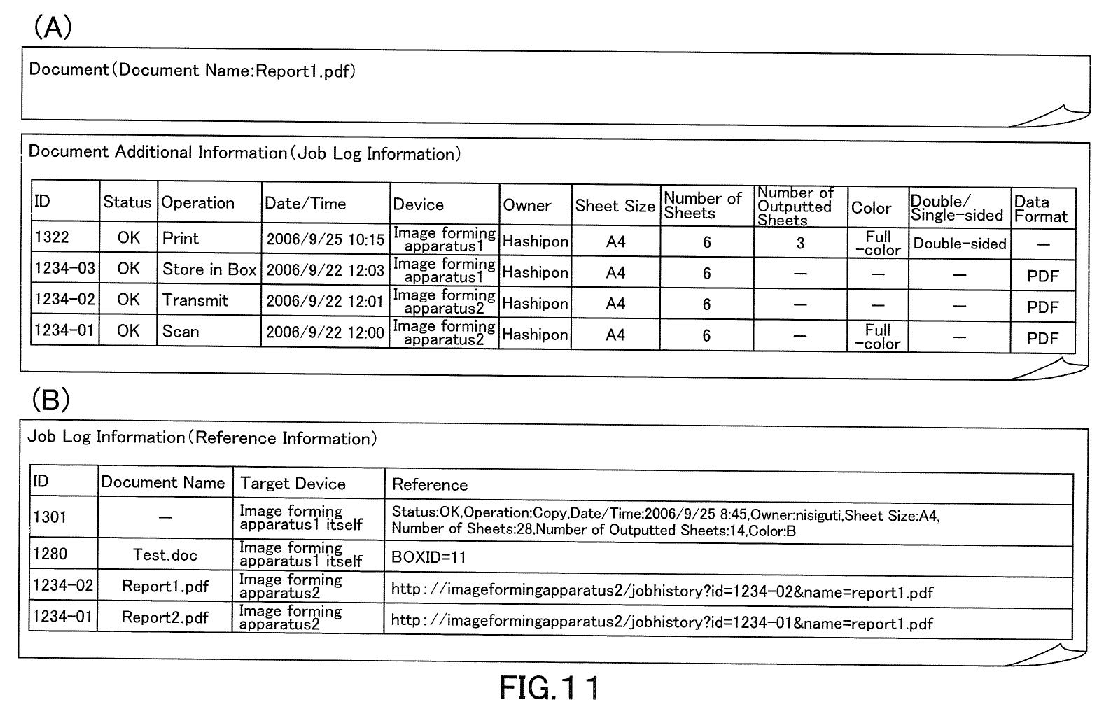

FIG. 11 is a view showing yet another example of a method to administrate job log information. In FIG. 10, detailed information of jobs executed on a document are stored in the job log information storage 151 in the image forming apparatuses 1 and 2, and reference information to refer to job log information of the executed jobs is given to the document, and then the document is transmitted. Meanwhile, as shown in the view [A] in FIG. 11, detailed information of jobs executed on a document in the respective image forming apparatuses are given to the document, as additional information. Then, the document and the additional information are stored together.

On the other hand, as shown in the view [B] in FIG. 11, reference information to refer to a document is stored as job log information, in the job log information storage 151 in respective image forming apparatuses. For example, a storage location in the image forming apparatus 2 is stored as reference information to refer to a document of the job ID 1234, as shown in the view [B], since the document is stored in the image forming apparatus 2. Similarly, a document of the job ID 1280 is stored in the box of number 11 in the image forming apparatus 1 itself. Meanwhile, a document of the job ID 1301 is a copy job and not stored. In this case, detailed information of the job is stored.

Further, when a document transmitted to the image forming apparatus 2 from the image forming apparatus 1, is further transmitted to the image forming apparatus 3 with detailed information of jobs executed on the document, a notice of the storage location in the image forming apparatus 3 (reference information) is transmitted to the image forming apparatuses 1 and 2, from the image forming apparatus 3. Then, the storage location stored in the job log information storage 151 in the image forming apparatuses 1 and 2, is changed to the storage location in the image forming apparatus 3.

In this way as described above, when a document is transmitted to another image forming apparatus, job log information indicating a job executed on the document in an image forming apparatus is given to the document. And based on the document, job log information indicating jobs sequentially executed in the respective image forming apparatuses are figured out. Further, reference information to track the document is stored as job log information in the image forming apparatus transmitting the document. Thus, the document is tracked based on the reference information.

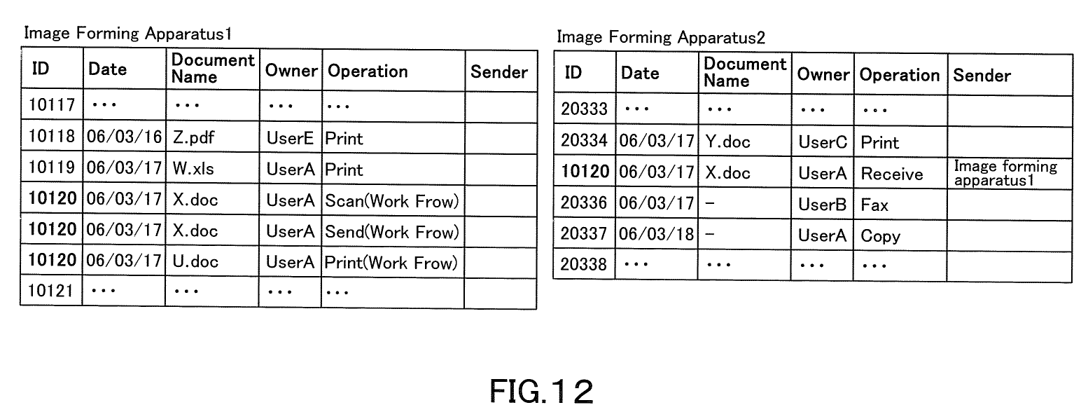

FIG. 12 is a view showing yet another example of a method to administrate job log information. In this embodiment, when a workflow is executed, a job ID given to a job of the workflow executed in the image forming apparatus 1 is continuously used for a job executed in the image forming apparatus 2.

In other words, the image forming apparatus has a function to register in advance as a workflow, an operating procedure (workflow) that is a set of a plurality of operations, so that users could call the workflow to perform easily often-used operations when he/she needs. For example, here is a workflow to read a document, and transmit image data read out from the document to another image forming apparatus, and then print another document that is stored in the box 152. The processes of the workflow are not to be executed on one same document, but are to be executed sequentially. Thus, as shown in FIG. 12, job log information of the respective processes are stored with the same job IDs 10120 in the job log information storage 151 in the image forming apparatus 1.

On the other hand, in the image forming apparatus 2 that receives the document transmitted by the transmitting process of the workflow, job log information indicating the job to receive the document is stored with the same job ID 120120, in the job log information storage 151.

Further, another configuration can be used although it is not shown in Figure, wherein a series of operations executed from login to logout, which are sequentially executed in the respective image forming apparatuses 1 through 6, are regarded as jobs related to each other, and the same job IDs are given to the respective executed operations no matter if the operations are executed on different documents. Thus, job log (operation log) information indicating a series of executed operations are more easily figured out.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image forming system comprising a plurality of image forming apparatuses interconnected via a network, wherein an image forming apparatus is capable of transmitting image data to another image forming apparatus, and the image forming apparatus transmitting the image data comprising:
a transmitter that transmits image data to another image forming apparatus;
a job log information storage; and
a job administrator that gives a job ID to job log information indicating a job executed on the image data then stores the job log information in said job information storage, and gives a job ID that is the same as or related to the job ID given to the job log information, to the image data to be transmitted by said transmitter, and
the image forming apparatus receiving the image data comprising:
a receiver that receives image data with a job ID, which is transmitted from another image forming apparatus;
a job log information storage; and
a job administrator that gives a job ID that is the same as or related to said job ID given to the image data received by said receiver, to job log information indicating a job executed on the image data, then stores the job log information in said job log information storage.

2. An image forming system as recited in claim 1, wherein said job administrator in the receiver image forming apparatus further relates sender information indicating the sender of said received image data, to the job ID given to the image data, then stores the sender information in said job log information storage.

3. An image forming system as recited in claim 1, wherein said plurality of image forming apparatuses are divided in more than two groups, and if the received image data is the one transmitted from another image forming apparatus belonging to the same group as the receiver image forming apparatus, said job administrator in the receiver image forming apparatus further gives a job ID that is the same or related to said job ID given to the image data, to the job log information indicating a job executed on the image data, then stores the job log information in said job log information storage.

4. An image forming system as recited in claim 1, wherein said job administrator in the sender image forming apparatus further gives reference information to refer to the job log information of a job executed on the image data, which is in the sender image forming apparatus itself, to the image data to be transmitted to another image forming apparatus.

5. An image forming system as recited in claim 1, wherein said job administrator in the sender image forming apparatus further gives the job log information of a job executed on the image data, which is in the sender image forming apparatus itself, to the image data to be transmitted to another image forming apparatus, then stores reference information to track the image data, as job log information in the job log information storage.

6. An image forming system as recited in claim 1, wherein said job administrator in the sender image forming apparatus or the receiver image forming apparatus gives job IDs that are the same as or related to each other, to job log information indicating respective processes of a workflow constructed in advance, which are sequentially executed on the image data.

7. An image forming apparatus capable of being interconnected to another image forming apparatus via a network, and comprising:
a transmitter that transmits image data to another image forming apparatus;
a receiver that receives image data transmitted from another image forming apparatus;
a job log information storage;
a job administrator that gives a job ID to job log information indicating a job executed on the image data then stores the job log information in said job log information storage, and gives a job ID that is the same as or related to the job ID given to the job log information, to the image data to be transmitted by said transmitter, and then, if the image data received by said receiver has a given job ID, gives a job ID that is the same as or related to said job ID given to the image data, to job log information indicating a job executed on the image data, then stores the job log information in said job log information storage.

8. An image forming apparatus as recited in claim 7, wherein said job administrator further relates sender information indicating the sender of said received image data, to the job ID given to the image data, then stores the sender information in said job log information storage.

9. An image forming apparatus as recited in claim 7, wherein if the received image data is the one transmitted from another image forming apparatus belonging to the same group as the image forming apparatus itself, said job administrator further gives a job ID that is the same as or related to said job ID given to the image data, to the job log information indicating a job executed on the image data, then stores the job log information in said job log information storage.

10. An image forming apparatus as recited in claim 7, wherein said job administrator further gives reference information to refer to the job log information of a job executed on the image data, which is in the image forming apparatus itself, to the image data to be transmitted to another image forming apparatus.

11. An image forming apparatus as recited in claim 7, wherein said job administrator further gives the job log information of a job executed on the image data, which is in the image forming apparatus itself, to the image data to be transmitted to another image forming apparatus, then stores reference information to track the image data, as job log information in said job log information storage.

12. An image forming apparatus as recited in claim 7, wherein said job administrator further gives job IDs that are the same as or related to each other, to job log information indicating respective processes of a workflow constructed in advance, which are sequentially executed on the image data.

13. A job administrating method used in an image forming system comprising a plurality of image forming apparatuses interconnected via a network, wherein the same job IDs or related job IDs to be shared among respective image forming apparatuses, are given to job log information of jobs sequentially executed in the respective image forming apparatuses on image data exchanged between the image forming apparatuses, and the job log information are administered by the job IDs.

14. A job administrating method comprising:
a step executed in an image forming apparatus transmitting image data, to give a job ID to job log information indicating a job executed on the image data then store the job log information in a job log information storage, and give a job ID that is the same as or related to the job ID given to the job log information, to the image data to be transmitted to another image forming apparatus;
a step executed in an image forming apparatus receiving image data, to receive the image data with the given ID, which is transmitted from said sender image forming apparatus; and
a step executed in said receiver image forming apparatus, to give a job ID that is the same as or related to said job ID given to the received image data, to job log information indicating a job executed on the image data, then store the job log information in the job log information storage.

15. A job administrating method as recited in claim 14, further comprising a step executed in said receiver image forming apparatus, to relate sender information indicating the sender of said received image data, to the job ID given to the image data, then store the sender information in said job log information storage.

16. A job administrating method as recited in claim 14, further comprising a step executed in said receiver image forming apparatus if the received image data is the one transmitted from another image forming apparatus belonging to the same group as the receiver image forming apparatus itself, to give a job ID that is the same as or related to said job ID given to the image data, to the job log information indicating a job executed on the image data, then store the job log information in said job log information storage.

17. A job administrating method as recited in claim 14, further comprising a step executed in said sender image forming apparatus, to give to the image data to be transmitted to another image forming apparatus, reference information to refer to the job log information of a job executed on the image data, which is in the sender image forming apparatus itself.

18. A job administrating method as recited in claim 14, further comprising a step executed in said sender image forming apparatus, to give to the image data to be transmitted to another image forming apparatus, the job log information of a job executed on the image data, which is in the sender image forming apparatus itself, then store reference information to track the image data, as job log information in the job log information storage.

19. A job administrating method as recited in claim 14, further comprising a step executed in said sender image forming apparatus or said receiver image forming apparatus, to give job IDs that are the same as or related to each other, to job log information indicating respective processes of a workflow constructed in advance, which are sequentially executed on the image data.

20. A job administrating program stored in a computer readable recording medium to make a computer in an image forming apparatus execute:
a step to transmit image data to another image forming apparatus via a network;
a step to receive image data transmitted from another image forming apparatus;
a step to give a job ID to job log information indicating a job executed on the image data then store the job log information in a job log information storage, and give a job ID that is the same as or related to the job ID given to the job log information, to the image data to be transmitted, and then, if the received image data has a given job ID, give a job ID that is the same as or related to the job ID given to the image data, to job log information indicating a job executed on the image data, then store the job log information in said job log information storage.

21. A job administrating program as recited in claim 20, further making a computer in an image forming apparatus execute a step to relate sender information indicating the sender of said received image data, to the job ID given to the image data, then store the sender information in said job log information storage.

22. A job administrating program as recited in claim 20, further making a computer in an image forming apparatus execute a step if the received image data is the one transmitted from another image forming apparatus belonging to the same group as the image forming apparatus itself, to give a job ID that is the same as or related to said job ID given to the image data, to job log information indicating a job executed on the image data, then store the job log information in said job log information storage.

23. A job administrating program as recited in claim 20, further making a computer in an image forming apparatus execute a step to give to the image data to be transmitted to another image forming apparatus, reference information to refer to the job log information indicating a job executed on the image data in the image forming apparatus itself.

24. A job administrating program as recited in claim 20, further making a computer in an image forming apparatus execute a step to give to the image data to be transmitted to another image forming apparatus, the job log information indicating a job executed on the image data in the image forming apparatus itself, then store reference information to track the image data, as job log information in the job log information storage.

25. A job administrating program as recited in claim 20, further making a computer in an image forming apparatus execute a step to give job IDs that are the same as or related to each other, to job log information indicating respective processes of a workflow constructed in advance, which are sequentially executed on the image data.
